(19) United States
(12) Patent Application Publication
(10) Pub. No.: US 2017/0212528 A1
(43) Pub. Date: Jul. 27, 2017

(54) Apparatus and Method for Autonomous Landing of an Aerial Vehicle

(71) Applicant: Patrick A. Henderson, Farmersville, TX (US)

(72) Inventor: Patrick A. Henderson, Farmersville, TX (US)

(21) Appl. No.: 15/006,460

(22) Filed: Jan. 26, 2016

(51) Int. Cl. G05D 1/06; G05D 1/10; B64F 1/00; B64C 39/02

(52) U.S. Cl. CPC G05D 1/0676; B64C 39/024; G05D 1/101; B64F 1/00; B64C 2201/18

(57) ABSTRACT

An apparatus and method of autonomously landing an aerial vehicle is disclosed herein. In a non-limiting embodiment, the apparatus is a landing pad controller that includes a plurality of receiving antennae, each of which is configured to receive an instance/version of a localization signal from the aerial vehicle. A localization calculation processor determines a precise position of the aerial vehicle based upon a comparison of the localization signal received by each of the plurality of receiving antennae. The landing pad controller also includes a transmitter that sends at least one course direction adjustment to the aerial vehicle, which can be used to direct the aerial vehicle from the precise position to a target landing area.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF INVENTION

1. Field of Invention

The present invention relates to operation of an aerial vehicle, and, more specifically, to an apparatus and method for autonomously landing the aerial vehicle.

2. Description of Related Art Including Information Disclosed Under 37 C.F.R. 1.97 and 1.98

An unmanned aerial vehicle (hereinafter “UAV”) is an aircraft designed for flying without a human pilot on board. UAVs are used in various industries and capacities. For example, UAVs are currently being used for reconnaissance, particularly in military operations, and some private companies are experimenting with UAV technology to deliver packages. Further, decreasing costs of UAVs and related equipment has resulted in the growth of UAV hobbyists.

Currently, UAVs may be remotely piloted by human pilots who may be located in the general vicinity of the aerial vehicle, or halfway around the world. UAVs may also be controlled automatically, such as through autopilot systems. Alternatively, UAVs may be controlled in part by a pilot and partly through automation. One aspect of autonomous flight that requires improvement is autonomous landing. As used herein, autonomous landing refers to the process of an UAV returning to the ground without human control. Autonomous landing does not require human interaction with the UAV at any point during the process, either during or after landing of the UAV. The ability to land a UAV in a target landing location is important because it obviates the need for an operator or owner to retrieve the UAV from a general landing location and relocate the UAV to a different location for storage, charging, or refueling. Such a task may be inconsequential for a hobbyist, but companies that may operate a fleet of thousands of UAVs would find it impractical to require human intervention to retrieve UAVs.

One currently used method for autonomously landing UAVs involves GPS technology. Landing coordinates are provided to the UAV, and onboard GPS systems identify the landing location. However, GPS technology is imprecise and can only be used to identify a general landing location, which may be a couple square feet in area. Thus, GPS technology cannot be used for precisely landing a UAV at a target landing spot.

Another type of currently used autonomous landing system implements infrared detectors that can be used to identify a precise landing location; however, IR detectors cannot always provide the accuracy and precision for autonomous landing of an aerial vehicle. With infrared detectors, obstacles such as sunlight and light reflections cause inaccuracies in the calculation of a flight path for the aerial vehicle. Furthermore, these detectors are linked to high energy consumption and prevents an efficient and power-saving solution for autonomous landing.

Another system and method of autonomous landing uses photo processors; however, these photo processors require additional equipment in the form of at least one camera. The added equipment reduces payload capacity and overall flight time. In addition, photo processing requires a high level of computational overhead to successfully land a UAV, which results in high energy consumption. Therefore this system and method of autonomous landing is an inefficient and inelegant solution for autonomous landing.

### BRIEF SUMMARY OF THE INVENTION

Disclosed herein is an apparatus, system, and related method, which may interface and may be implemented with an aerial vehicle, for the purpose of precisely and autonomously landing the aerial vehicle on a target landing area.

In accordance with one embodiment of the present invention, an apparatus and method for autonomously landing an aerial vehicle are provided which substantially eliminates or reduces disadvantages associated with previous systems.

In accordance with another embodiment, a landing pad controller for autonomously landing an aerial vehicle is provided. The landing pad controller comprises a plurality of receiving antennae that receives a localization signal from the aerial vehicle, and each of the receiving antennae receives an instance/version of the localization signal. The landing pad further comprises a localization calculation processor that determine a precise position of the aerial vehicle based upon a comparison of the localization signal received by each of the receiving antennae; a logic controller processor coupled to the localization calculation processor, which determines at course adjustment information based on the precise position and the target landing area; and a transmitter that sends the course adjustment information to the aerial vehicle, and the course adjustment information directs the aerial vehicle from the precise position to a target landing area. In another embodiment, at least one of the receiving antennae may be a transmitter as well as a receiver, and therefore, the antenna may be a transceiver.

In accordance with another embodiment, method in a landing pad controller for autonomously landing an aerial vehicle is provided. The method comprises establishing a communication session with the aerial vehicle; receiving a localization signal from the aerial vehicle; determining a precise position of the aerial vehicle based on the localization signal; generating course adjustment data usable to direct the aerial vehicle from the precise position to a target landing area; and transmitting the course adjustment information to the aerial vehicle. The In other embodiments, the method also comprises comparing at least one property of the localization signal as received by each of a set of receiving antennae. The property may be phase of the signal, time of arrival of the signal, frequency of arrival of the signal, or gain of the signal. The method may also comprise receiving the localization signal at a set of receiving antennae, where each of the set of receiving ante is spaced no more than half wavelength apart. The method may also comprise storing the landing area of the aerial vehicle.

In accordance with another embodiment, an aerial vehicle configured for autonomous landing is provided. The aerial vehicle comprises a signal generator that generates a localization signal; a localization output antenna that transmits the localization signal to a landing pad controller; a communication interface that receives course adjustment information from the landing pad controller; and a flight controller that implements the course adjustment information to direct the aerial vehicle from a precise position to a target landing area. In other embodiments, the aerial vehicle also comprises a signal amplifier that amplifies the localization signal generated by the signal generator. The aerial vehicle may also comprise a filtering circuit that filters the localization signal generated by the signal generator.

In accordance with another embodiment of the present invention, a method in an aerial vehicle configured for autonomous landing is provided. The method comprises of establishing a communications session with a landing pad controller at a landing location in response to arriving at the landing location; transmitting a localization signal to the landing pad controller; receiving course adjustment data, which directs the aerial vehicle from its current location to a target landing area, from the landing pad controller; and landing the aerial vehicle at the target landing area. The method may further comprise receiving coarse position information to identify the landing location. The course positioning information may be received from either a global positioning system, or a wireless telecommunications network. The method may also comprise the course adjustment data calculated from a comparison of the precise position of the aerial vehicle relative to the target landing area. The precise position of the aerial vehicle may be calculated by comparing at least one property of the localization signal as received by the landing pad controller. In other embodiments, the method may further comprise adjusting a position of the aerial vehicle with reference to course adjustment information. The method may also comprise ceasing transmission of the localization signal upon landing.

At least one advantage attributable to novel aspects of the present disclosure is increasing the resource efficiency in autonomous landing systems. Prior autonomous landing systems require cameras, light detection, infrared sensors, etc., and these components, when attached to a drone, increase power consumption and use more resources. On the other hand, other autonomous landing systems, while somewhat resource efficient, did not provide the precision and accuracy achievable by the previously mentioned systems, such as GPS. The present invention provides resource efficiency with a high level of precision and accuracy in autonomous landing. For example, the localization signal as disclosed by the present invention does not require much energy from the aerial vehicle to transmit. The calculation of the position of the aerial vehicle also does not expend many resources or require much power consumption because the calculation uses principles of signals processing in the calculation and does so without heavy computation that would consume much power. Further, the aerial vehicle receives information for altering its flight path and does not require its independent processing and calculation, such as used by image recognition, light detection, and infrared sensors.

### BRIEF DESCRIPTION OF THE DRAWINGS

The present invention will be more fully understood by reference to the following detailed description of the preferred embodiments of the present invention when read in conjunction with the accompanying drawings, wherein:

FIG. 1 depicts an embodiment of a system that enables autonomous landing of an aerial vehicle configured for vertical takeoff and landing.

FIG. 2 illustrates a block diagram of a landing pad controller in accordance with an illustrative embodiment.

FIG. 3 illustrates an exemplary block diagram of a transmitter controller configured for autonomous landing in accordance with an illustrative embodiment

FIG. 4 is a flow chart of a method in a landing pad controller for autonomously landing an aerial vehicle, in accordance with an illustrative embodiment.

FIG. 5 is a flow chart of a method in an aerial vehicle for autonomous landing, in accordance with an illustrative embodiment.

The above-referenced figures are provided herein for the purpose of illustration and description only, and are not intended to define the limits of the disclosed invention. Use of the same reference number in multiple figures is intended to designate the same or similar parts. Furthermore, when the terms “top,” “bottom,” “first,” “second,” “upper,” “lower,” “height,” “width,” “length,” “end,” “side,” “horizontal,” “vertical,” and similar terms are used herein, it should be understood that these terms have reference only to the structure shown in the drawing and are utilized only to facilitate describing the particular embodiment. The extension of the figures with respect to number, position, relationship, and dimensions of the parts to form the preferred embodiment will be explained or will be within the skill of the art after the following teachings of the present invention have been read and understood.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits and/or memory storing program instructions executable to implement the operation. The memory can include volatile memory such as static or dynamic random access memory and/or nonvolatile memory such as optical or magnetic disk storage, flash memory, programmable read-only memories, etc. The hardware circuits may include any combination of combinatorial logic circuitry, clocked storage devices such as flops, registers, latches, etc., finite state machines, memory such as static random access memory or embedded dynamic random access memory, custom designed circuitry, programmable logic arrays, etc. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. §112(f) interpretation for that unit/circuit/component.

In an embodiment, hardware circuits in accordance with this disclosure may be implemented by coding the description of the circuit in a hardware description language (HDL) such as Verilog or VHDL. The HDL description may be synthesized against a library of cells designed for a given integrated circuit fabrication technology, and may be modified for timing, power, and other reasons to result in a final design database that may be transmitted to a foundry to generate masks and ultimately produce the integrated circuit. Some hardware circuits or portions thereof may also be custom-designed in a schematic editor and captured into the integrated circuit design along with synthesized circuitry. The integrated circuits may include transistors and may further include other circuit elements (e.g. passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

### DETAILED DESCRIPTION OF THE INVENTION

A portion of the disclosure of this patent document contains material which is subject to copyright protection. The copyright owner has no objection to the facsimile reproduction by anyone of the patent document or the patent disclosure, as it appears in the Patent and Trademark Office patent file or records, or otherwise reserves all copyright rights whatsoever.

In the view of the foregoing, through one or more various aspects, embodiments and/or specific features or sub-components, the present disclosure is thus intended to bring out one or more of the advantages that will be evident from the description. The present disclosure makes reference to one or more specific embodiments by way of illustration and example. It is understood, therefore, that the terminology, examples, drawings, section, and embodiments are illustrative and not intended to limit the scope of the disclosure.

The term “computer processing device” or computing device means any electrical device capable or accepting stored program instructions from a computer readable medium and processing those program instructions to perform a defined task. Such devices include, but are not limited to, a mainframe, workstation, desktop, laptop, notebook, or tablet computer, a database server, web server, or the like. One of ordinary skill in the art will appreciate that the construction, choice of programming language, programming, operation, and functionality of such computer processing devices is well known, rendering further description of such devices unnecessary in this regard.

The system of the present invention can be implemented on a computing device platform that is capable of local or remote access by a user. For example, the computing devices can a stored program computer such as a desktop, laptop, server, mainframe, or the like, including but not limited to a RISC or CISC processor, a DSP, a programmable logic device or the like, capable of executing program instructions. Further it is possible that the system may utilize any one or some combination of the aforementioned devices. Choice of hardware and implementation is considered within the skill of one of ordinary skill in the art for which the invention applies.

The process steps of the present invention can be implemented in high or low level programming or scripting languages, such as Basic, C, C++, C#, .NET, Jscript, Java, or the like. Further, some combination of programming utilities may be utilized to achieve the process steps of the invention. Choice of programming language and implementation is considered to be within the skill of one of ordinary skill in the art for which the invention applies.

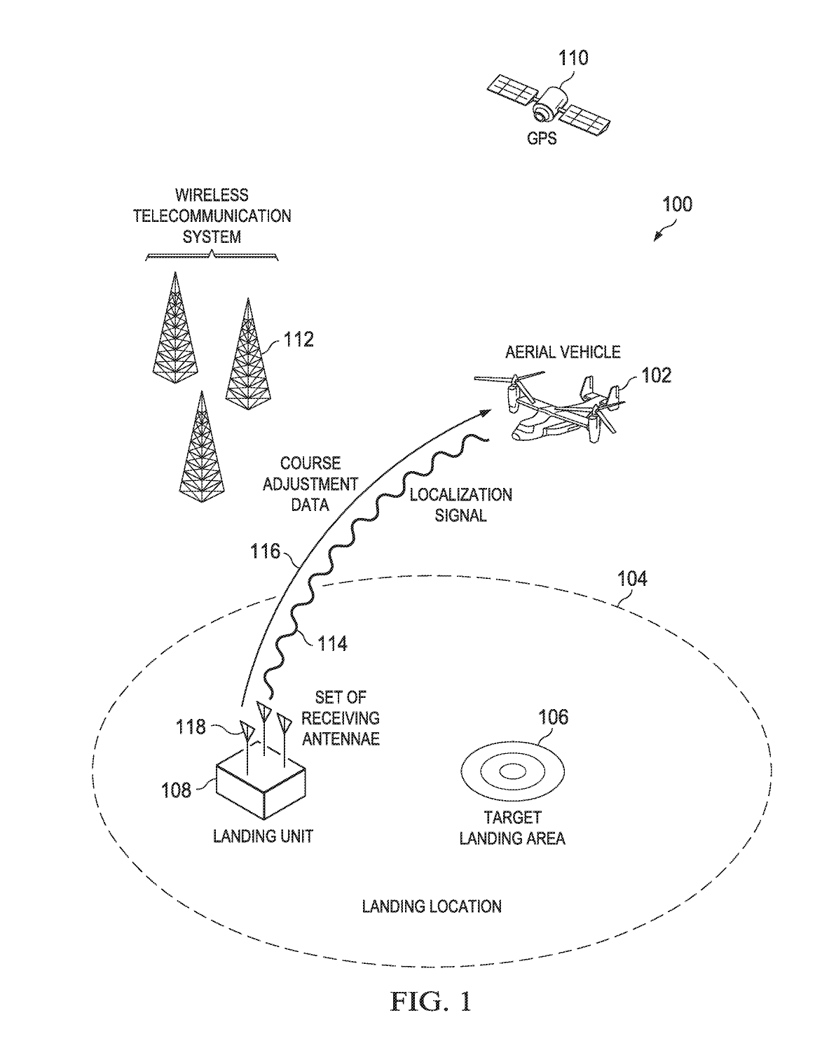

FIG. 1 depicts an embodiment of a system that enables autonomous landing of an aerial vehicle capable of vertical takeoff and landing. Autonomous landing system 100 facilitates the landing of aerial vehicle 102 at a target landing area 106 located within a general landing location 104 serviced by a landing unit 108. The target landing area 106 is a precisely defined area assignable to a specific aerial vehicle, such as aerial vehicle 102. The target landing area 106 may be a landing pad, charging station, or storage location sized to accommodate aerial vehicle 102. Although FIG. 1 depicts only a single target landing area 106, target landing area 106 may be one of a plurality of target landing areas located in close proximity with one another, each of which may be assigned to a different aerial vehicle. Accordingly, each aerial vehicle in a fleet of incoming aerial vehicles may be guided to a different target landing area 106.

The target landing area 106 may be predetermined, or the target landing area 106 may be dynamically determined before or during the landing process. Dynamically determining the target landing area 106 may occur when an obstacle appears within the airspace of the landing location 104 or on the ground of the landing location 104. Furthermore, the target landing area 106 may be identified by an absolute position or a relative position from landing unit 108.

The autonomous landing of aerial vehicle 102 is initiated once the aerial vehicle 102 has entered the airspace of landing location 104. The aerial vehicle 102 may be guided to the landing location 104 any number of ways. For example, aerial vehicle 102 may be piloted by a human operator or the aerial vehicle 102 may automatically navigate toward the general landing location 104 on autopilot. Autonomous navigation may utilize any currently existing or later developed technology or guidance system, which may be located internally or externally from aerial vehicle 102. In a non-limiting embodiment, the aerial vehicle 102 may utilize positioning data received from coarse positioning systems, such as GPS 110 or telecommunications systems 112, to determine its location or flight path. These telecommunications systems 112 may include cellular networks, Wi-Fi networks, or any type of network available for the aerial vehicle 102. Additionally, coordinates of landing location 104 may be transmitted to aerial vehicle 102, or the coordinates may be stored in memory.

In this non-limiting example of FIG. 1, landing location 104 corresponds with the area in which aerial vehicle 102 and landing unit 108 can communicate over wireless channels. Thus, the size of landing location 104 may change dynamically based upon the transmission power of the various communications systems implemented by aerial vehicle 102 and landing unit 108.

As an initial step in the autonomous landing process, a communications session is established between aerial vehicle 102 and landing unit 108. The communications session may be established by any known method or protocol, and may include any number of ancillary steps, such as aerial vehicle detection and authentication. Further, the communications session may occur on any available frequency, as prescribed by FCC regulations.

Once the communication session is established, aerial vehicle 102 transmits a localization signal 114 to the landing unit 108. The localization signal 114 is a sinusoidal radar signal and/or electrical signal having certain characteristics, e.g., wavelength, phase, power, bandwidth, etc. The signal may be an analog signal or a digital signal, and may contain any other relevant information for landing unit 108. Localization signal 114 may be transmitted continuously or intermittently by aerial vehicle 102.

Localization signal 114 is received by landing unit 108, which analyzes characteristics of localization signal 114 to determine the precise location of the aerial vehicle 102 in three-dimensional space relative to landing unit 108. The landing unit 108 may then transmit back to the aerial vehicle 102 course adjustment data 116 so that aerial vehicle 102 may make appropriate adjustments to its flight path to land on the target landing area 106. The course adjustment data 116 may take the form of a new or updated flight path for the aerial vehicle 102, or alternatively, course adjustment data 116 may be adjustments to an existing flight path of aerial vehicle 102. Alternatively, the course adjustment data 116 may be raw location data usable by the aerial vehicle 102 to determine its location relative to the flight path or transmit the location references to the aerial vehicle 102 so that the aerial vehicle 102 may determine how to get to target landing area 106.

The landing unit 108 may be connected to or in communication with a set of receiving antennae 118. The landing unit 108 uses set of receiving antennae 118 in receiving the messages from aerial vehicle 102. Information regarding the phase, frequency, timing, and other related properties of localization signal 114 from the aerial vehicle may be used by the landing unit 108 to determine the position of aerial vehicle 102 relative to receiving antennae 118 and landing unit 108, or relative to any other position at the target landing area.

Set of receiving antennae 118 may comprise at least three receiving antennae. The antennae may comprise of any type of antennae capable of receiving signals from aerial vehicle 102. For example, set of receiving antennae 118 may comprise ceramic antennae that are directional and attenuated in nature. The properties of the antennae may also be considered for processing localization signal 114 received by the antennae 118. Choice of hardware and implementation is considered within the skill of one of ordinary skill in the art for which the invention applies.

Furthermore, set of receiving antennae 118 is placed at any location within area of or around the landing location 118. Set of receiving antennae 118 may be attached to landing unit 108, or alternatively, the antennae 118 may form separate component for placement within or around the area of landing location 104. Additionally, each antenna of set of receiving antennae 118 may be placed at or within half a wavelength's distance from each other. Autonomous landing system 100 uses differences in the properties of localization signal 114 in order to determine the position of aerial vehicle 102, and autonomous landing system 100 gathers information regarding these differences by placing each antenna of set of receiving antennae 118 at certain distances from each other in order to effectuate those differences. So, autonomous landing system 100 transmits localization signal 114 at a predetermined frequency f, and for an electrical signal travelling at the speed of light c (=3×10 meters/second), the relationship between a wavelength λ and frequency f is

$$λ = \frac{c}{f} .$$

Based on this principle, the wavelength of the predetermined frequency f may be determined, and the set of receiving antennae 118 may be placed accordingly. The wavelength of the predetermined frequency f may vary depending on the medium through which the electrical signal is travelling because the speed of light c may vary when passing through different mediums, e.g., air, water, etc.

Landing unit 108 transmits course adjustment data 116 to aerial vehicle 102. The course adjustment data 116 may be transmitted by a separate transmitting antenna, or by at least one of set of receiving antennae 118. At least one of set of receiving antennae 118 may be a transceiver, and allows landing unit 108 to transmit course adjustment data 108 to aerial vehicle 102. When landing unit 108 receives localization signal 114 from aerial vehicle 102, landing unit 108 calculates course adjustment data 116 for the aerial vehicle 102 using the differences of localization signal 114 as received by each antennae of set of receiving antennae 118.

In an alternate embodiment of the present invention, each antenna of the set of receiving antennae 118 forms a separate unit, where the antennae is attached to this separate unit. The separate unit contains a processor for processing of the localization signal 114 as received by the antennae of the unit. The information that results from the processing is then either communicated to a central processor distinct from the antennae units, or to an antenna unit that acts as a central hub for the calculation of course adjustment data 116. Whether a separate processor or an antenna unit acts as the central processor for course adjustment data 116 calculation, an antenna of set of receiving antennae 118 transmits course adjustment data 116 to aerial vehicle 102.

The process of transmitting course adjustment data 116 from an antennae of set of receiving antennae 118 differs from the current state of the art in landing guidance, such as Instrument Landing System (ILS). ILS uses difference in depth of modulation in order to define a position for the aerial vehicle in airspace. Devices of ILS provide radio frequency signals that vary in the depth of modulation. The antenna in this alternate embodiment would not be transmitting analog signals that vary in modulation depth, but would be transmitting digital signals to be created by the landing unit 108 and processed by aerial vehicle 102 using digital signal processing, not analog signals processing. Also, the present invention removes the positioning calculations that would be performed by aerial vehicle 102 in ILS by offloading the localization calculation onto landing unit 108 and transmitting course adjustment data 116. With positioning calculations done by the landing unit 108 instead of aerial vehicle 102, the present invention frees up resources for aerial vehicle 102, such as power, processing power, etc., and reduces the amount of equipment needed aboard aerial vehicle 102 and the weight of aerial vehicle 102 itself. Furthermore, ILS only provides assistance in pilot-guided landings, while the present invention is designed for autonomous landings.

In another alternative embodiment of the present invention, autonomous landing system 100 facilitates the landing of aerial vehicle 102 using sensors at target landing area 106. The sensors detect the weight or presence of aerial vehicle 102 and transmits a message to landing unit 108. In turn, landing unit 108 transmits a message to aerial vehicle 102 through course adjustment data 116 that indicates that aerial vehicle 102 has completed the landing process.

In this illustrative embodiment of FIG. 1, landing unit 108 is depicted separate and apart from target landing area 106. However, in an alternate embodiment, landing unit 108 acts as target landing area 106. Landing unit 108 provides a landing structure that supports aerial vehicle 102 and acts as target landing area 106. For example, target landing area 106 can be a landing pad integrated with landing unit 108. Landing unit 108 calculates the position of aerial vehicle 102 relative to landing unit 108 and calculates course adjustment data 116 with landing unit 108 as target landing area 106.

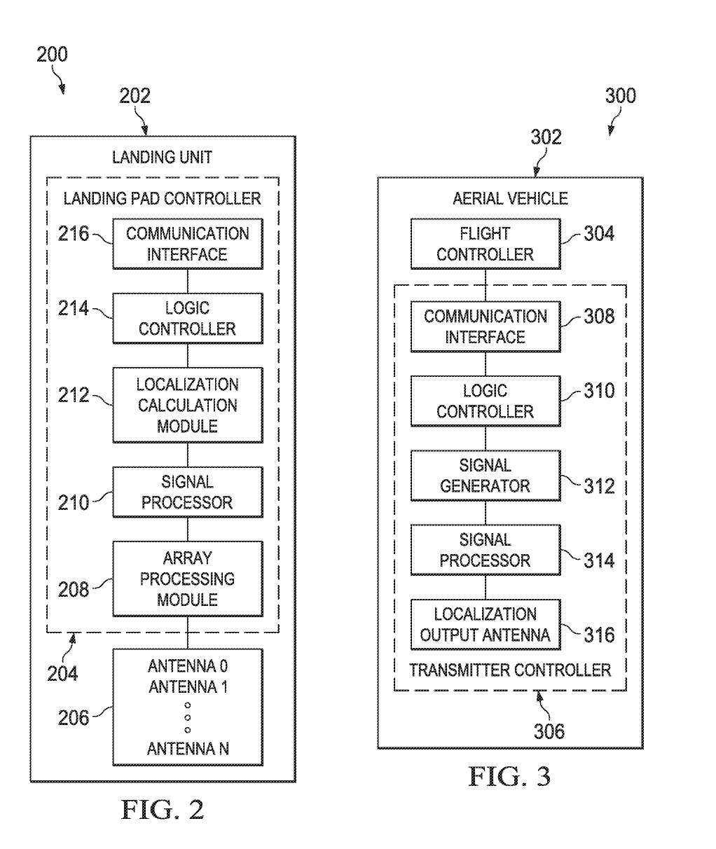

FIG. 2 illustrates a block diagram 200 of a landing pad controller in accordance with an illustrative embodiment. The landing pad controller 204 may be implemented in landing unit 202, such as and also represented as landing unit 108 in FIG. 1. The landing pad controller comprises set of receiving antenna 206, an antennae array processor 208, signal processor 210, localization calculation processor 212, logic controller processor 214, and communication interface 216

Set of receiving antennae 206, also represented in FIG. 1 as set of receiving antennae 118, receives signals from the aerial vehicle. Set of receiving antennae 206 may comprise at least three antennae. Any number of antennae greater than three antennae may enhance the precision and accuracy of the course adjustment data as calculated by localization calculation processor 212. However, three antennae provides the minimum amount of information for calculating the position of the aerial vehicle by localization calculation processor 212. With three antennae, the antenna of set of receiving antennae 206 receives localization signal from the aerial vehicle, and the localization signal becomes three different signals with different signal properties and components, such as time, delay, and phase.

Array processor 208 identifies and organizes the signals/data received by each antennae of set of receiving antennae 206. A person of ordinary skill in the art would know and understand how to process the array of antennae signals for further signals processing. Array processor 208 sends the identified signals to the signals processor 210.

Signals processor 210 receives identified signals from array processor 208 and transmits processed information to localization calculation processor 212. Signal processor 210 analyzes and processes the identified signals using conventional digital signal processing techniques. A person skilled in the art would know and understand how to process the signal as received by each of the antennae in set of receiving antennae 206. Signal processor 210 may extract information about each identified and received signal, e.g., phase, frequency, and delay. This information as determined and analyzed by signal processor 210 is transmitted to localization calculation processor 212.

Localization calculation processor 212, as previously mentioned, receives information and data from the signals processor 210. Localization calculation processor 212 uses this information to determine the location of the aerial vehicle in the airspace of the landing location. Localization calculation processor 212 uses a lateralization process or any other type of localization process in order to determine the aerial vehicle's position in the airspace of the landing location.

Each antennae of the landing pad controller 204 receives the generated signal from the aerial vehicle. Localization calculation processor 212 of landing pad controller 204 measures the generated signal as separate signals as received by each antenna of set of receiving antennae 206. Because set of receiving antennae 206 includes any number of antennae equal to or greater than three antennae, localization calculation processor 212 increases the precision and accuracy of the aerial vehicle's position when using all the received signals from the antennae 206.

Localization calculation processor 212 measures the difference of phase of each received signal at a specific frequency since each antenna of set of receiving antennae 206 receives the localization signal at different locations within half a wavelength's distance. The differences in phase will not be greater than half a wavelength because the antennae are located at or within half a wavelength's distance from one another. In an exemplary embodiment of the present invention, when the aerial vehicle is on the same plane as the antennae and adjacent to the antennae, the difference in signal phase as received by each of the antennae 206 will be at its maximum of half a wavelength. For all other positions, the phase difference is less than half a wavelength. When the aerial vehicle is exactly between two antennae of the set of receiving antennae 206, the phase difference between the two antennae is zero.

Using the phase differences, localization calculation processor 212 may determine in what position the aerial vehicle is located relative to landing unit 202. The phase difference between two antennae of set of receiving antennae 206 describes an arc in space because aerial vehicle 102 may be located anywhere so long as aerial vehicle 102 is at a distance coinciding with the calculated phase difference, which therefore describes an arc in space. Because every pairing of antennae provides a different phase difference calculation, the localization calculation processor 212 calculates three distance and therefore a point in space using the three distances. A person of ordinary skill in the art may also use other signal properties, such as gain and time, and other signal methods, such as frequency-modulated continuous wave, in order to calculate the location of aerial vehicle 102. More details for multilateration techniques are disclosed in “Differential Doppler target position fix computing methods” by J. Vesely published in IEEE Proceedings of the International Conference on Circuits, Systems, and Signals (pp. 294-287); in “Algorithms for Location Estimation Based on RSSI Sampling” by Charalampos Papamanthou et al., published in Algorithmic Aspects of Wireless Sensor Networks, Springer Berlin Heidelberg, 2008 (pp 72-86); in “Multilateration” on Wikipedia: The Free Encyclopedia, updated on 4 Jan. 2016, accessed 15 Jan. 2016<https://en.wikipedia.org/wiki/Multilateration>; and in “FDOA” on Wikipedia: The Free Encyclopedia, updated on 12 Dec. 2012, accessed 15 Jan. 2016 <https://en.wikipedia.org/wiki/FDOA>, which are hereby incorporated by reference in their entirety.

Logic control processor 214 receives messages from localization calculation processor 212 and sends instructions to the communication interface 216 for transmission to the aerial vehicle. Logic control processor 214 provides control signals for the communication interface 216, and is configured to provide for the automation of landing pad controller 204. Logic control processor 214 may provide power to the landing pad controller 204 through a power supply or connection to a power supply. Any type of microcontroller or microprocessor unit can be used as logic controller processor 214. Any array of logic components capable of implementing the present invention can function as logic controller processor 214.

Communication interface 216 may be connected to or in communication with the aerial vehicle 102. Generally, communication interface 216 transmits course adjustment data to the aerial vehicle 102 through a transmitting antenna as depicted in FIG. 1. Course adjustment data contains information about the location of the aerial vehicle 102 relative to the landing unit 202, and the aerial vehicle 102 calculate adjustments to the aerial vehicle's flight path based on the relative location of the aerial vehicle 102 to the target landing area. Alternatively, course adjustment data may contain a flight plan for the aerial vehicle 102.

In an alternative embodiment of the present invention, landing pad controller 204 includes a signal generator, similar to signal generator 312 of FIG. 3. The signal generator of the landing pad controller 204 creates a digital signal for transmission to the aerial vehicle. The signal generation processor send this generated signal to communication interface 216, and the communication interface 216 transmits this generate signal to the aerial vehicle through a transmitting antenna. In this alternate embodiment, set of receiving antennae 206 includes antennae that both receive and transmit signals from and to the aerial vehicle, and so set of receiving antennae 206 can transmit course adjustment data to the aerial vehicle.

Any type of communication protocol may be used, such as UART, I2C, SSI, etc. in the transmission of data from landing pad controller 204 to the aerial vehicle. A person of ordinary skill in the art may implement the communication between the communication interface 216 and the transmitter controller using any secure communication protocol.

FIG. 3 illustrates an exemplary block diagram 300 of a transmitter controller configured for autonomous landing in accordance with an illustrative embodiment. The transmitter controller 306 may be implemented in aerial vehicle 302, such as and represented as aerial vehicle 102 in FIG. 1. Alternatively, the transmitter controller may be implemented as an external device that communicates with the aerial vehicle 302. The transmitter controller 306 comprises a communication interface 308, a logic controller processor 310, signal generation processor 312, signal amplification and filtering processor 314, and a localization output antenna 316. FIG. 3 also depicts a flight controller 304 implemented in the aerial vehicle. The aerial vehicle uses the flight controller 304 for flight processes, e.g., navigation, controlling flight mechanisms of the aerial vehicle.

When entering the airspace of the landing location, the aerial vehicle establishes a communication link using transmitter controller 306 to landing pad controller 204. Alternatively, the transmitter controller 306 may determine that the aerial vehicle has entered the airspace of the landing location when landing pad controller 204 establishes communication with transmitter controller 306.

After transmitter controller 306 and landing pad controller 204 have established a communication link, transmitter controller 306 receives information from the landing pad controller 204 using the communication interface 308. Landing pad controller 204 transmits course adjustment data, as depicted in FIG. 1, and the communication interface 308 receives the course adjustment data before transmitting the information to logic controller 310.

Logic controller processor 310 receives the information from communication interface 308 and transmits messages back to communication interface 308, instructing communication interface 308 to send the messages to devices in communication with the communication interface 308. Logic controller processor 310 is configured to provide the automation of transmitter controller 306. Logic controller processor 310 also sends instructions to signal generation processor 312 when a localization signal needs to be sent, and instructions include information regarding frequency, phase, delay, content, etc. of the generated signal. Logic controller processor 310 may provide power to transmitter controller 306 through a power supply or connection to a power supply. Any type of microcontroller or microprocessor unit can be used as logic controller processor 310. Any array of logic components capable of implementing the present invention can function as logic controller processor 310.

Signal generation processor 312 receives instructions from logic controller processor 310 on properties of a generated signal. For example, logic controller processor 310 may instruct signal generation processor 312 to generate a signal at a certain frequency and phase with a certain amount of delay. Signal generation processor 312 may also generate a signal that contains control data, and this control data is known to the landing pad controller 204 of landing unit 202. This control data allows multiple instances for the landing pad controller 204 to assist in the calculation of the position of the aerial vehicle. The signal generated by signal generation processor 312 may then be transmitted to signal amplification and filtering processor 314.

Signal amplification and filtering processor 314 receives a generated signal from signal generation processor 312, and sends an amplified and filtered version of the generated signal to localization output antenna 316. Signal amplification and filtering processor 314 uses an appropriate filter in order to filter out certain parts of the generated signal and amplifies the generated signal to an amplitude so that landing pad controller 204 receives the generated signal clearly and accurately.

Localization output antenna 316 receives the amplified and filtered signal from signal amplification and filtering processor 314, and broadcasts the received signal. The broadcasted signal of the present invention differs from other landing guidance methods such as ILS. Other landing guidance methods such as ILS uses space modulation techniques in order to define a position for the aerial vehicle in airspace. The present invention uses differences in signal properties as received by landing pad controller 204, while ILS and other current state of the art techniques measure differences in modulation depth in amplitude modulation.

As mentioned previously, any type of communication protocol may be used, such as UART, I2C, SSI, etc.

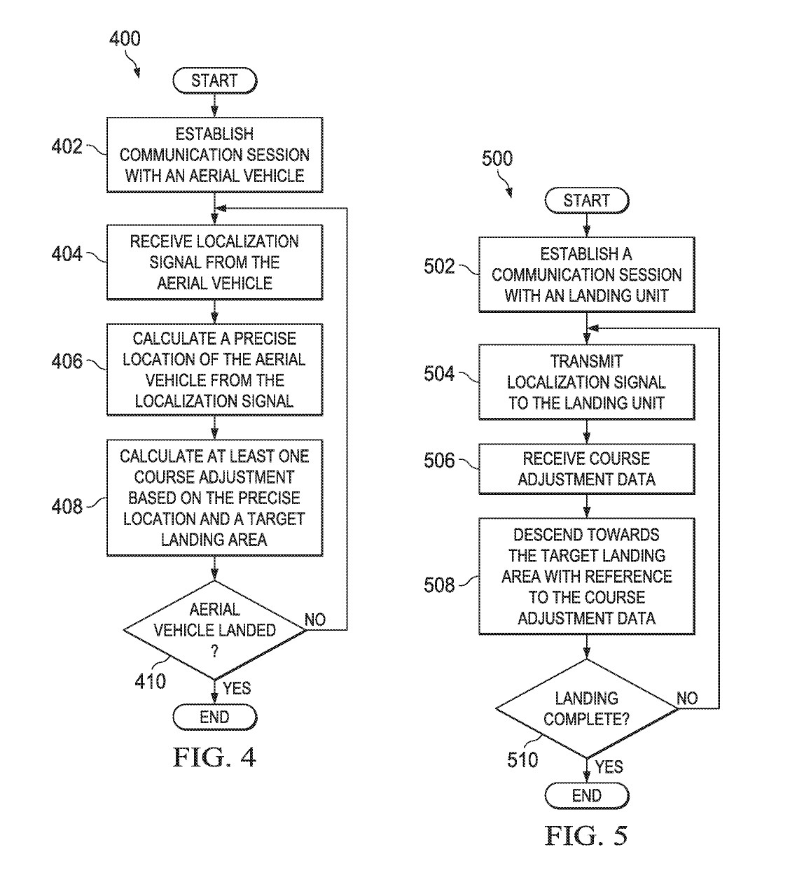

FIG. 4 is a flowchart of a method for in a landing pad controller for autonomously landing an aerial vehicle, in accordance with an illustrative embodiment. The method may be implemented in a control station, such as landing unit 108 in FIG. 1. The method begins by establishing a communications session with an aerial vehicle 102 (Step 402). The communications session may be initiated by any currently existing or later developed method. For example, step 402 may include a detection step to establish the presence of the aerial vehicle 102 within the airspace of general landing location 104. The detection step may be achieved by receiving identification information from a third party, such as an air traffic controller. Alternatively, the aerial vehicle 102 may broadcast its identity periodically or upon reaching a predetermined location. In another embodiment, the landing unit 108 may include equipment capable of detecting aerial vehicle 102. In addition, step 402 may also include an authentication step that confirms an identity of the aerial vehicle 102. The authentication step may also associate the aerial vehicle 102 with a particular target landing area 106 to which the aerial vehicle 102 should be directed.

After the communication session has been established, a localization signal 114 is received from the aerial vehicle 102 (Step 404). The localization signal 114 is received at a set of receiving antennae 118. More specifically, each of the set of receiving antennae 118 receives a different instance/version of the localization signal 114.

Upon receiving the localization signal 114 from the aerial vehicle 102, the landing pad controller may then calculate a precise position of the aerial vehicle relative to the ground (Step 406). The precise position may be an absolute position, or it may be a location relative to a fixed point, such as the landing pad controller or the target landing area 106.

Subsequently, the landing pad controller may then calculate at least one course adjustment for the aerial vehicle (Step 408). The at least one course adjustment is usable by the aerial vehicle 102 to land on the predetermined target landing area 106.

The landing pad controller then may determine whether the aerial vehicle 102 has landed (Step 410). If the landing pad controller determines that the aerial vehicle 102 has not landed, then the process returns to Step 404. However, if the landing pad controller determines that the aerial vehicle 102 has landed, then the process terminates.

FIG. 5 is a flow chart of the method in an aerial vehicle for autonomous landing, in accordance with an illustrative embodiment. The method may be implemented in an aerial vehicle, such as aerial vehicle 102 in FIG. 1. Upon entering an airspace above the landing location 104, a communication session is established (Step 502). As mentioned earlier with respect to Step 402 in FIG. 4, the communication session may be established using any method or protocol and include any number of ancillary steps. Once the communication session has been established, the aerial vehicle 102 transmits a localization signal for receipt by a landing unit (Step 504).

Thereafter, the aerial vehicle 102 receives course adjustment data 116 from the landing unit (Step 506) and descends towards the target landing area 106 with reference to course adjustment data 116 (Step 508). A determination is then made as to whether landing has been completed (Step 510). If landing has been completed, then the method terminates; however, if landing has not been completed, then the method returns to Step 504.

In an alternate embodiment of the present invention, when the course adjustment data indicates that the aerial vehicle is directly above the target landing area, the transmitter controller 306 provides instructions to the flight controller 304 to vertically descend. This alternate embodiment contemplates the aerial vehicle in the airspace of the landing location and above the target landing area, but the aerial vehicle is only vertically displaced from the target landing area. However, in this embodiment, where the aerial vehicle is also laterally displaced from the target landing area, the aerial vehicle continues broadcasting the localization signal to the landing unit. The landing unit repeats the process of receiving the localization signal, calculating course adjustment data, and transmitting the course adjustment data to the transmitter controller.

In a further alternate embodiment of the present invention, the position of the aerial vehicle does not match the previously calculated position of the aerial vehicle. For example, environmental factors, such as wind, can move the aerial vehicle during the process of determining the aerial vehicle's position. The aerial vehicle continues the process of broadcasting a localization signal and receiving course adjustment data until the aerial vehicle receives information that indicates that the aerial vehicle has landed on the target landing area. The rationale for this alternate embodiment is that the unknown factors may prevent the aerial vehicle from staying on its intended flight path, and this alternate embodiment provides repetition of the autonomous landing method until landing has occurred.

In another alternate embodiment of the present invention, the autonomous landing system is configured to accommodate more than one aerial vehicle. The landing pad controller stores the target landing areas of previously landed aerial vehicles, and uses its dynamic determination of a target landing area for another aerial vehicle that needs to land. This alternate embodiment contemplates a situation where the landing unit and the landing location facilitate the autonomous landing of multiple aerial vehicles.

As indicated above, aspects of this invention pertain to specific “method functions” implementable through various computer systems. In an alternate embodiment, the invention may be implemented as a computer program product for use with a computer system. Those skilled in the art should readily appreciate that programs defining the functions of the present invention can be delivered to a computer in many forms, which include, but are not limited to (a) information permanently stored on non-writeable storage media (e.g., read only memory devices within a computer such as ROMs or CD-ROM disks readable only by a computer I/O attachment); (b) information alterably stored on writeable storage media (e.g., floppy disks and hard drives); or (c) information conveyed to a computer through communication media, such as a local area network, a telephone network, a public network like the Internet. It should be understood, therefore, that such media, when carrying computer readable instructions that direct the method functions of the present invention, represent alternate embodiments of the present invention.

The invention may be embodied in other specific forms without departing from the spirit or essential characteristics thereof. The present embodiments are therefore to be considered in all respects as illustrative and not restrictive. Accordingly, the scope of the invention is established by the appended claims rather than by the foregoing description. All changes which come within the meaning and range of equivalency of the claims are therefore intended to be embraced therein. Further, the recitation of method steps does not denote a particular sequence for execution of the steps. Such method steps may therefore be performed in a sequence other than recited unless the particular claim expressly states otherwise.

What is claimed:

1. A landing pad controller for autonomously landing an aerial vehicle, the landing pad unit comprising:
a plurality of receiving antennae that receives a localization signal from the aerial vehicle, wherein each of the plurality of receiving antennae receives an instance/version of the localization signal;
a localization calculation processor that determines a precise position of the aerial vehicle based upon a comparison of the localization signal received by each of the plurality of receiving antennae;
a logic controller processor coupled to the localization processor, wherein the logic controller processor determines at least one course direction adjustment based on the precise position and the target landing area; and
a transmitter that send the at least one course adjustment data to the aerial vehicle, wherein the course adjustment data directs the aerial vehicle from the precise position to a target landing area.

2. The landing pad controller of claim 1, wherein at least one of the plurality of receiving antenna is a transceiver, and wherein the transceiver comprises the transmitter.

3. An aerial vehicle configured for autonomous landing, the aerial vehicle comprising:
a signal generator that generates a localization signal;
a localization output antenna that transmits the localization signal to a landing pad controller;
a communication interface that receives at least one course adjustment from the landing pad controller; and
a flight controller that implements the at least one course adjustment to direct the aerial vehicle from a precise position to a target landing area

4. The aerial vehicle of claim 3, further comprising:
a signal amplifier that amplifies the localization signal generated by the signal generator.

5. The aerial vehicle of claim 4, further comprising:
a filtering circuit that filters the localization signal generated by the signal generator.

6. A method in a landing pad controller for autonomously landing an aerial vehicle, the method comprising:
establishing a communication session with the aerial vehicle;
receiving a localization signal from the aerial vehicle;
determining a precise position of the aerial vehicle based on the localization signal;
generating course adjustment data usable to direct the aerial vehicle from the precise position to a target landing area; and
transmitting the course adjustment data to the aerial vehicle.

7. The method of claim 6, wherein determining the precise position of the aerial vehicle further comprises:
comparing at least one property of the localization signal as received by each of a set of receiving antennae.

8. The method of claim 7, wherein the at least one property of the localization signal is phase.

9. The method of claim 7, wherein the at least one property of the localization signal is time of arrival.

10. The method of claim 7, wherein the at least one property of the localization signal is frequency of arrival.

11. The method of claim 7, wherein the at least one property of the localization signal is gain.

12. The method of claim 6, wherein receiving the localization signal further comprises:
receiving the localization signal at a set of receiving antennae, wherein each of the set of receiving antenna is spaced no more than a half wavelength apart.

13. The method of claim 6, further comprising:
storing the target landing area of the aerial vehicle.

14. A method in an aerial vehicle for autonomous landing, the method comprising:
establishing a communications session with a landing pad controller at a landing location in response to arriving at the landing location;
transmitting a localization signal to the landing pad controller;
receiving course adjustment data from the landing pad controller, wherein the course adjustment data directs the aerial vehicle from its current location to a target landing area; and
landing the aerial vehicle at the target landing area.

15. The method of claim 14, further comprising:
receiving coarse positioning information to identify the landing location.

16. The method of claim 15, wherein the coarse positioning information is received from one of a global positioning system (GPS) and a wireless telecommunications network.

17. The method of claim 14, wherein the course adjustment data is calculated from a comparison of a precise positioning information of the aerial vehicle relative to the target landing area.

18. The method of claim 14, wherein the precise positioning information is calculated by comparing at least one property of the localization signal as received by the landing pad controller.

19. The method of claim 14, further comprising:
adjusting a position of the aerial vehicle with reference to course adjustment data.

20. The method of claim 14, further comprising:
ceasing transmission of the localization signal upon landing.
